(19) United States
(12) Patent Application Publication
(10) Pub. No.: US 2009/0226223 A1
(43) Pub. Date: Sep. 10, 2009

(54) TRANSFER DEVICE, CONVEYING DEVICE AND IMAGE FORMING APPARATUS INCLUDING THESE DEVICES

(76) Inventors: Toshiki TAKIGUCHI, Yamatokoriyama-shi (JP); Hideshi Izumi, Ikoma-shi (JP); Takahiko Yoshida, Nara-shi (JP); Hiroyuki Murai, Yamatokoriyama-shi (JP)

Correspondence Address: BIRCH STEWART KOLASCH & BIRCH, PO BOX 747, FALLS CHURCH, VA, 22040-0747, US

(21) Appl. No.: 12/389,549

(22) Filed: Feb. 20, 2009

(30) Foreign Application Priority Data
Mar. 7, 2008 (JP) 2008-57216

(51) Int. Cl. G03G 15/16

(52) U.S. Cl. 399/312

(57) ABSTRACT

A transfer device is configured to include a drive roller, a driven roller and a transfer belt supported between these rollers and provided with first and second guide ribs extending circumferentially at both side edges on the undersurface thereof and a drive roller, so as to prevent the transfer belt from skewing by making the drive roller and driven roller abut at both ends against first and second inner circumferential surfaces of the first and second guide ribs. The drive roller and the driven roller are specified to have a length approximately equal to each other and shorter than the spacing between the first and second inner circumferential surfaces and arranged such that the first spacing between a first end of the drive roller on the drive gear side and the first guide rib is wider than the second spacing between a second end of the driven roller on the drive gear side and the first guide rib.

This Nonprovisional application claims priority under 35 U.S.C. §119(a) on Patent Application No. 2008-57216 filed in Japan on 7 Mar. 2008, the entire contents of which are hereby incorporated by reference.

### BACKGROUND OF THE INVENTION

(1) Field of the Invention

The present invention relates to a transfer device and conveying device including a drive roller, a driven roller and a belt tensioned and supported between, and circulated by, these rollers and an image forming apparatus including these devices.

(2) Description of the Prior Art

There is a known image forming apparatus in which a photoreceptor drum is arranged on the paper feed path that is defined by a transfer belt which holds and conveys a sheet of paper so that the toner image formed on the photoreceptor drum is transferred to the sheet to form an image thereon. In this image forming apparatus, as the transfer belt is tensioned and supported between, and circulated by, a plurality of tensioning rollers, there has been the problem that the belt tends to deviate sidewards of these tensioning rollers due to dimensional distortion of the transfer belt, misalignment between the multiple tensioning rollers and the like. As a result of this, there has occurred image mis-registration in color image printing.

To deal with this, in the image forming apparatus disclosed in patent document 1 (Japanese Patent Application Laid-open 2002-333779), a pair of guide ribs 152 are formed at the side edges along the circumferential direction of a transfer belt 151 as shown in FIG. 1 so that the inner circumferential surfaces of these guide ribs 152 will abut the both sides ends of a driven roller 154 to thereby regulate the sideward movement of transfer belt 151. In addition, driven roller 154 is designed to have a greater length (in the width direction of transfer belt 151) than the length of a drive roller 153. In this way, drive roller 153 will not get involved in regulation of the transfer belt with guide ribs 152, hence the frictional force between transfer belt 151 and drive roller 153 becomes stable and image mis-registration can be made small.

However, in the image forming apparatus of patent document 1, when drive roller 153 is adapted so as not to get involved in regulating the transfer belt with guide ribs 152 by making the length of drive roller 153 shorter than the length of driven roller 154, there is the risk that the movement of transfer belt 151 conversely becomes unstable.

In particular, when drive roller 153 is being driven, flexure 155 arises as shown in FIG. 2 (as indicated by arrows 156) and transfer belt 151 tends to travel, approaching the center of drive roller 153 due to its elasticity. Further, when the drive gear for driving drive roller 153 is disposed on one end side of drive roller 153, transfer belt 151 is distorted due to reactive force to the driving force since drive roller 153 is rotationally driven from one side. As a result, a skewing force 157 acting on transfer belt 151 arises, causing a skew.

On the other hand, when the drive roller and the driven roller are designed to have approximately the same length so that drive roller 153 can take a role of regulating the transfer belt in cooperation with the guide ribs, if the end face of the driven roller comes to be positioned lower than that of the drive roller due to the tolerance and the design looseness in the thrust direction, the guide rib of the transfer belt for preventing a skew abuts the end face of the drive roller and is positioned at the more interior side, and may climb over the drive roller unable to create steady engagement, in the worst case. As a result, the guide ribs will not produce any preventive effect against skewing and the transfer belt starts to skew. If the belt skews extremely, the transfer belt is wrinkled while continuing to skew. If this condition continues, the transfer belt may rupture or may be locked due to its rotational failure.

### SUMMARY OF THE INVENTION

In view of what has been discussed above, it is an object of the present invention to provide a transfer device or a conveying device including drive and driven rollers and a transfer or conveying belt with guide ribs, which can prevent the guide ribs from climbing over the drive roller and prevent the belt from skewing, by shifting one roller to the other with respect to the width direction, as well as to provide an image forming apparatus including these devices.

The first aspect of the present invention resides in a transfer device comprising: a transfer belt to which an image formed on an image bearer is transferred; a drive roller that receives a drive force via a drive gear arranged at one end thereof; and a driven roller that receives no drive force, characterized in that the transfer belt is tensioned and supported between, and conveyed by, the two rollers, the transfer belt has first and second guide ribs formed on the undersurface thereof, the drive roller and the driven roller are specified to have a length approximately equal to each other and shorter than the spacing between the first and second inner circumferential surfaces of the first and second guide ribs, and the drive roller and the driven roller are arranged such that the first spacing between a first end of the drive roller on the drive gear side and the first guide rib is wider than the second spacing between a second end of the driven roller on the drive gear side and the first guide rib.

The second aspect of the present invention resides in a conveying device comprising: a conveying belt for conveying sheets; a drive roller that receives a drive force via a drive gear arranged at one end thereof; and a driven roller that receives no drive force, characterized in that the conveying belt is tensioned and supported between, and conveyed by, the two rollers, the conveying belt has first and second guide ribs formed on the undersurface thereof, the drive roller and the driven roller are specified to have a length approximately equal to each other and shorter than the spacing between the first and second inner circumferential surfaces of the first and second guide ribs, and the drive roller and the driven roller are arranged such that the first spacing between a first end of the drive roller on the drive gear side and the first guide rib is wider than the second spacing between a second end of the driven roller on the drive gear side and the first guide rib.

Herein, the belt may have an endless belt configuration.

Further, the third aspect of the present invention resides in an image forming apparatus which, at least, include either the transfer device or the conveying device.

According to the present invention, the transfer belt or the conveying belt first and second guide ribs formed on the undersurface thereof, the drive roller and the driven roller are specified to have a length approximately equal to each other and shorter than the spacing between the first and second inner circumferential surfaces of the first and second guide ribs, and the drive roller and the driven roller are arranged such that the first spacing between a first end of the drive roller on the drive gear side and the first guide rib is wider than the second spacing between a second end of the driven roller on the drive gear side and the first guide rib. As a result, when the belt is started to convey, it is possible to prevent the guide rib of the belt from climbing over the drive roller for conveying the belt on its drive gear side, hence prevent the transfer belt from skewing

### BRIEF DESCRIPTION OF THE DRAWINGS

FIG. 1 is a schematic view showing a transfer device in patent document 1;

FIG. 2 is an illustrative view showing the principle of the skewing of a transfer belt;

FIG. 3 is a schematic view showing the overall configuration of an image forming apparatus to which one embodiment of a transfer device of the present invention is applied;

FIG. 4 is a configurational view showing a transfer device;

FIG. 5 A is a schematic plan view showing a transfer device;

FIG. 5B is a sectional view showing a transfer belt 31 and guide ribs 61; and

FIG. 6 is a view showing an experiment on the skewing of a transfer belt in a transfer device.

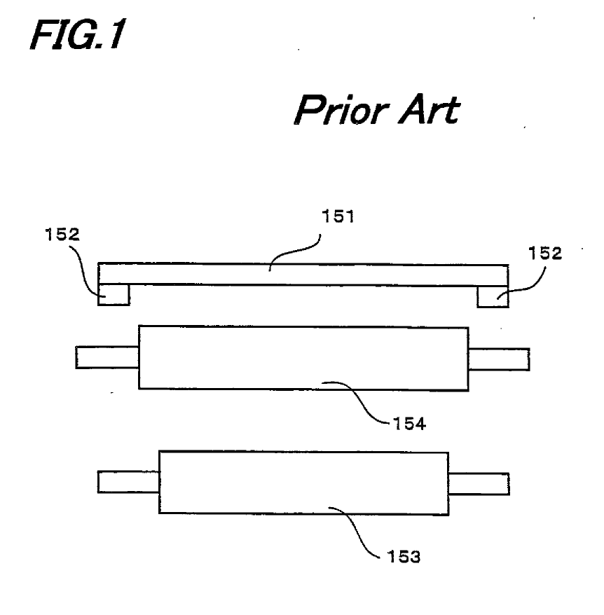

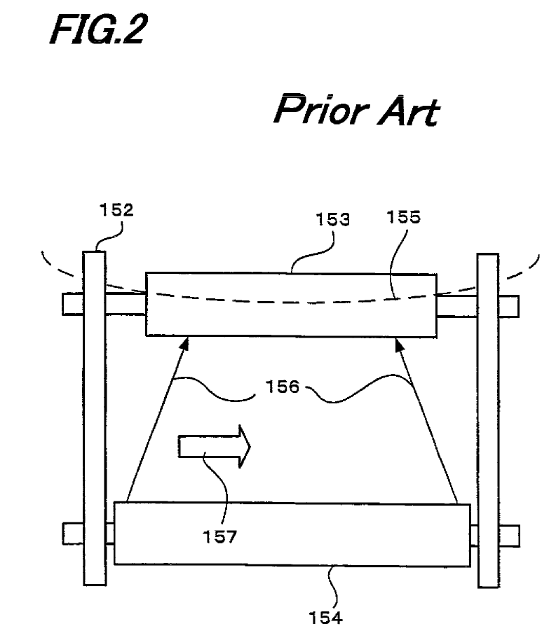

### DESCRIPTION OF THE PREFERRED EMBODIMENTS

Next, one embodiment of the present invention will be described in detail with reference to the accompanying drawings.

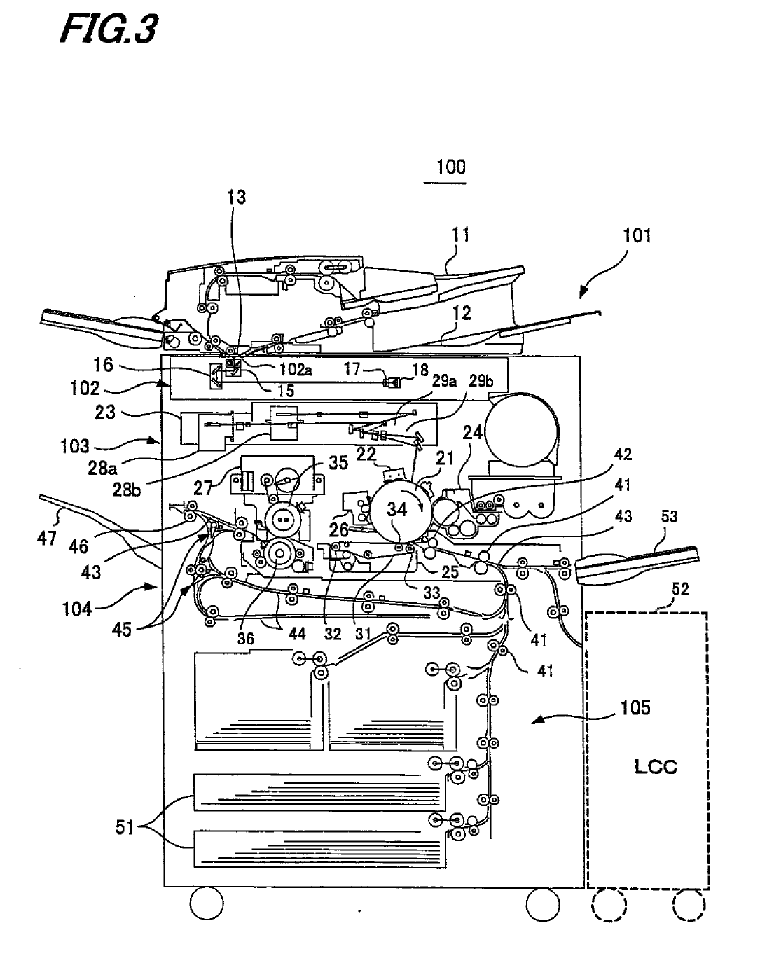

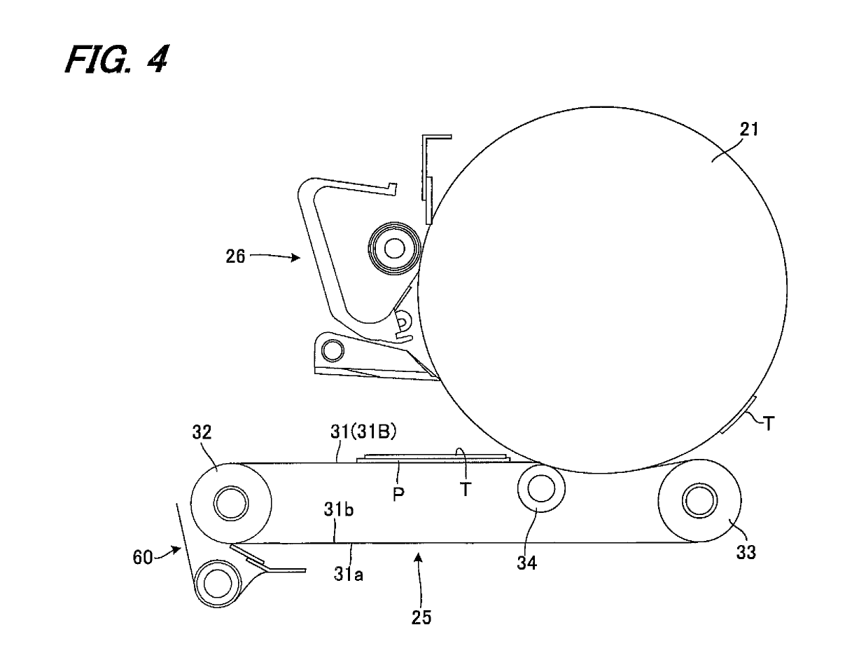

FIG. 3 is a schematic view showing the overall configuration of an image forming apparatus to which one embodiment of the transfer device of the present invention is applied. FIG. 4 is a configurational view showing the transfer device.

An image forming apparatus 100 is to form a monochrome image represented by the image data that is obtained by scanning a document or that is received from without, and is essentially comprised of a document sheet feeder (ADF) 101, an image reader 102, a printing portion 103, a recording sheet conveyor 104 and a paper feeder 105.

As will be detailed layer, the paper conveying device of the present embodiment is applied to document sheet feeder (ADF) 101 and recording sheet feeder 104. In document sheet feeder 101, the fluctuation of the conveyed position of document sheets is inhibited by controlling the front end feed operation of the document sheets in accordance with the rigidity of the document sheets. In recording sheet feeder 104, the fluctuation of the conveyed position of recording sheets is inhibited by controlling the front end feed operation of the recording sheets in accordance with the rigidity of the recording sheets.

In document feeder 101, when, at least, one document sheet is set on a document set tray 11 and the document sheets are pulled out from document set tray 11, sheet by sheet, the document is conducted to and passed over a document reading window 102a of image reader 102 and discharged to a document output tray 12.

A CIS (contact image sensor) 13 is arranged over document reading window 102a. This CIS 13 repeatedly reads the image on the underside of the document in the main scan direction while the document is passing over document reading window 102a, to thereby output the image data that represents the image on the underside of the document.

Further, image reader 102 illuminates the document surface with light from the lamp of a first scan unit 15 when the document sheet passes over document reading window 102a and the reflected light from the document sheet surface is lead to an image focusing lens 17 by way of the mirrors of first and second scan units 15 and 16, so that the image on the document sheet surface is focused by image focusing lens 17 onto a CCD (charge coupled device) 18. CCD 18 repeatedly reads the image of the document sheet surface in the main scan direction to thereby output image data that represents the image on the document sheet surface.

On the other hand, when the document sheet is placed on the platen glass on the top of image reader 102, first and second scan units 15 and 16 are moved keeping a predetermined speed relationship relative to each other while the document sheet surface on the platen glass is illuminated by first scan unit 15, and the light reflected off the document sheet surface is lead to image focusing lens 17 by means of first and second scan units 15 and 16 so that the image on the document sheet surface is focused by image focusing lens 17 onto CCD 18.

The image data output from CIS 13 or CCD 18 is subjected to various kinds of image processes by a control circuit such as a microcomputer etc. and then output to printing portion 103.

Printing portion 103 is to record the document images represented by image data on sheets of paper and includes a photoreceptor drum 21, a charger 22, an optical writing unit 23, a developing device 24, a transfer device 25, a cleaning unit 26, a fusing unit 27 and the like.

While photoreceptor drum 21 rotates in one direction, its surface is cleaned by cleaning unit 26 and then charged uniformly by charger 22. Charger 22 may be either a corona discharge type or a roller or brush type that contacts with photoreceptor drum 21.

Optical writing unit 23 is a laser scanning unit (LSU) including two laser emitters 28a and 28b and two mirror groups 29a and 29b. This optical writing unit 23 receives image data and emits laser beams from laser emitters 28a and 28b in accordance with the image data. These laser beams are radiated on photoreceptor drum 21 by way of respective mirror groups 29a and 29b to thereby illuminate the photoreceptor drum 21 surface that has been uniformly electrified, forming an electrostatic latent image on the photoreceptor drum 21 surface.

In order to achieve a high-speed printing operation, this optical writing unit 23 employs a two-beam system including two laser emitters 28a and 28b to thereby reduce the burden entailing the high frequency of irradiation.

Here, as the optical writing unit 23, an array of light emitting elements, e.g., an EL writing head or LED writing head may be used instead of the laser scanning unit.

Developing device 24 supplies toner to the photoreceptor drum 21 surface to develop the electrostatic latent image into a toner image T (FIG. 4) on the photoreceptor drum 21 surface. Transfer unit 25 transfers the toner image T on the photoreceptor drum 21 surface to the sheet P that is conveyed by sheet conveyor 104. Fusing unit 27 heats and presses the recording sheet P to fix the toner image T onto the recording sheet P. There after, the recording sheet P is further conveyed by sheet conveyor 104 and discharged to a paper output tray 47. In this while, cleaning unit 26 removes and collects the toner left over on the photoreceptor drum 21 surface after development and transfer.

Here, as shown in FIG. 4, transfer unit 25 includes a transfer belt 31, drive roller 32, driven roller 33, elastic conductive roller 34 and the like, and rotates transfer belt 31 by supporting and tensioning the belt on the aforementioned rollers 32 to 34 and other rollers. Transfer belt 31 has a predetermined resistivity (e.g., 1×10⁹ to 1×10¹³ Ω/cm) and conveys the recording sheet P placed on its surface 31a. Elastic conductive roller 34 is pressed against the photoreceptor drum 21 surface with transfer belt 31 in between, so as to press the recording sheet P on the surface 31a of transfer belt 31 against the photoreceptor drum 21 surface. Applied to this elastic conductive roller 34 is an electric field that has a polarity opposite to the charge of the toner image T on the photoreceptor drum 21 surface. This electric field of the opposite polarity causes the toner image T on the photoreceptor drum 21 surface to transfer to the recording sheet P on transfer belt 31. For example, when the toner image T bears negative (−) charge, the polarity of the electric field applied to elastic conductive roller 34 is set to be positive (+). The toner left over on transfer belt 31 is removed by a transfer cleaning unit 60.

Fusing unit 27 includes a heat roller 35 and pressing roller 36. A heater is arranged inside heat roller 35 in order to set the heat roller 35 surface at a predetermined temperature (fusing temperature: approximately 160 to 200 deg. C.). A pair of unillustrated pressing members are arranged at both ends of pressing roller 36 so that pressing roller 36 comes into pressing contact with heat roller 35 with a predetermined pressure. As the recording sheet P reaches the pressing contact portion (called as the fusing nip portion) between heat roller 35 and pressing roller 36, the unfixed toner image T on the recording sheet P is fused and pressed while it is being conveyed by the rollers 35 and 36, so that the toner image T is fixed to the recording sheet P.

Sheet conveyor 104 includes a plurality of conveying rollers 41 for conveying recording sheet P, a pair of registration rollers 42, a conveyance path 43, an inversion/conveyance path 44, a plurality of branch claws 45, a pair of paper discharge rollers 46 and the like.

Conveyance path 43 receives the recording sheet delivered from paper feeder 105 and conveys the recording sheet P until its leading end reaches registration rollers 42. Since registration rollers 42 are temporarily suspended at that timing, the leading end of the recording sheet P reaches and abuts registration rollers 42 and the sheet bends. The resiliency of this bent recording sheet P makes the front edge of the recording sheet P substantially parallel to registration rollers 42. Thereafter, registration rollers 42 start rotating so as to convey the recording sheet P to transfer unit 25 of printing portion 103 and then the recording sheet P is further conveyed by paper discharge rollers 46 to paper output tray 47.

Suspension and rotation of registration rollers 42 can be controlled by switching on or off the clutch between registration roller 42 and its drive shaft or by turning on or off the motor as the drive source of registration rollers 42.

When another image is recorded on the rear side of the recording sheet P, a plurality of branch claws 45 are turned to switch the paper path from conveyance path 43 to inversion/conveyance path 44 so that the recording sheet P is turned upside down and returned through inversion/conveyance path 44 to registration rollers 42 in conveyance path 43. In this way, another image will be recorded on the rear side of the recording sheet.

Arranged at the necessary positions along conveyance path 43 and inversion/conveyance path 44 are several sensors for detecting the position of the recording sheet etc., and based on the position of the recording sheet detected at each sensor, the drives of the conveying rollers and registration rollers are controlled so as to convey and position the recording sheet.

Paper feeder 105 includes a plurality of paper feed trays 51. Each paper feed tray 51 is a tray for holding a stack of recording sheets P and is arranged under image forming apparatus 100. Also, each paper feed tray 51 includes a pickup roller or the like for pulling out recording sheets, one by one, so as to deliver the picked up recording sheet to conveyance path 43 of sheet conveyor 104.

Since image forming apparatus 100 of the present embodiment is aimed at high speed printing processing, each paper feed tray 51 has a volume capable of stacking 500 to 1500 sheets of recording paper P of a regular size.

Arranged on the flank of image forming apparatus 100 are a large capacity paper cassette (LCC) 52 for accommodating large amounts of a plurality of types of recording sheets P and a manual feed tray 53 for essentially supplying recording sheets P of irregular sizes.

Paper output tray 47 is arranged on the side opposite from manual feed tray 53. It is also possible to optionally provide an output paper finisher (for stapling, punching, etc.) or a multi-bin paper output tray, in place of the paper output tray 47.

As transfer belt 31, a film-formed material made of a flexible and unstretchable resin so as not to impede smooth rotation as a transfer belt is usually used. As the examples of such resin, publicly known thermoplastic resin, thermoplastic elastomer, thermosetting resin and the like can be listed.

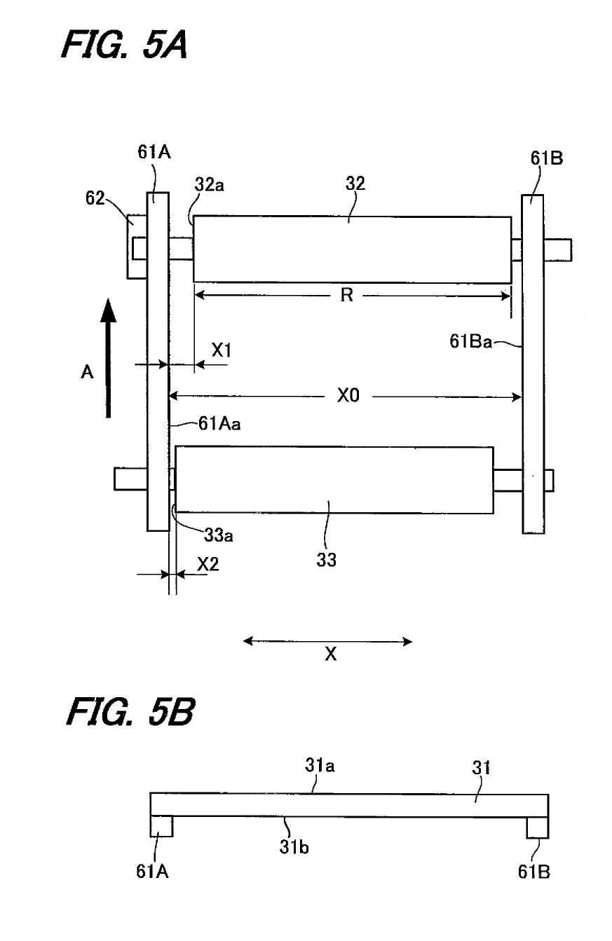

FIG. 5A is a schematic plan view showing a transfer device. FIG. 5B is a sectional view of transfer belt 31 and guide ribs 61.

Transfer belt 31 has an outer surface 31 and an undersurface 31b, and a pair of endless guide ribs 61A and 61B (first and second guide ribs) formed circumferentially along both the side edges, with respect to the width direction of transfer belt 31. That is, guide ribs 61A and 61B are formed projectively on undersurface 31b of transfer belt 31.

These guide ribs 61A and 61B abut both ends of drive roller 32 and driven roller 33 on their inner circumferential surfaces 61Aa and 6Ba (first and second inner circumferential surfaces) so as to limit sideward movement of transfer belt 31.

The drive roller and driven roller are specified to have approximately the same length R (with respect to the width direction of transfer belt 31, designate at X) and to be shorter than the distance, designated at X0, between inner circumferential surfaces 61Aa and 61Ba. Transfer belt 31 tensioned and supported between drive roller 32 and driven roller 33 is conveyed in the direction of arrow A in FIG. 5A.

A drive gear 62 is arranged at the left side of drive roller 32, so that the drive power from a driving motor is transmitted to drive roller 32 via drive gear 62. In this arrangement, drive roller 32 and driven roller 33 are arranged such that the spacing, designated at X1 (the first spacing) between the end, designated at 32a (the first end) of drive roller 32 on the drive gear 62 side and the inner circumferential surface 61Aa of guide rib 61A (the first guide rib) on the drive gear 62 side is wider than the spacing, designated at X2 (the second spacing) between the end, designated at 33a (the second end) of driven roller 33 on the drive gear 62 side and the inner circumferential surface 61Aa (X1>X2). This arrangement of drive roller 32 and driven roller 33 makes it possible to prevent guide rib 61 from climbing over drive roller 32, hence prevent transfer belt 31 from skewing. This will be detailed hereinbelow.

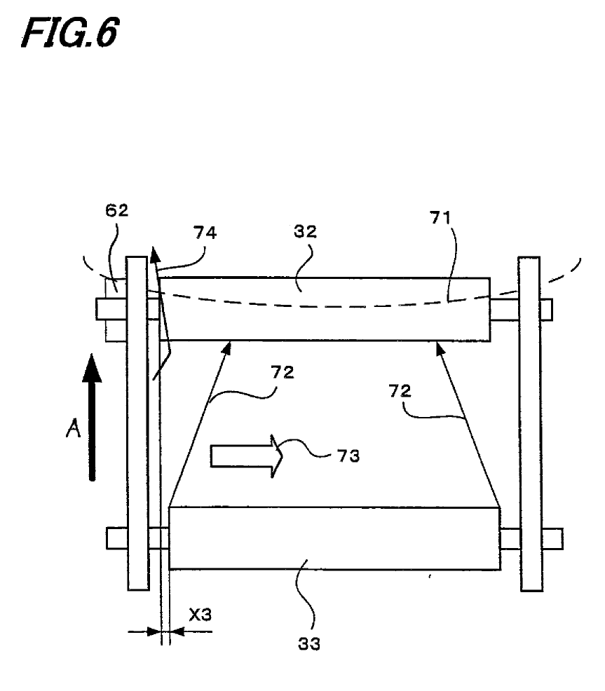

FIG. 6 is an illustration when the experiment for examining the skew of transfer belt 31. The arrangement is the same as that shown in FIGS. 5A and 5B, but the experiment was carried out by changing spacings X1 and X2.

In this case, the projected amount X3 of drive roller 32 to the left from the left side end 33a of driven roller 33 was varied to observe the skew of the transfer belt. The result is shown in Table 1 below.

TABLE 1

| Projected Amount (X3) | Skew |
|---|---|
| 1.05 mm | XX |
| 0.80 mm | X |
| 0.4 mm | X |
| 0.05 mm | ◯ |
| 0.00 mm | ◯ |
| −0.05 mm | ◯ |
| −0.04 mm | ◯ |
| −0.80 mm | ◯ |
| −1.05 mm | ◯ |

Here, when the projected amount X3 is negative, this implies that the left side end 32a of drive roller 32 is positioned to the right from the left side end 33a of driven roller 33.

From the observation result, when the projected amount X3 was 0.05 mm or lower, or when the left side end 32a of drive roller 32 was not projected a distance greater than 0.05 mm leftwards from left side end 33a of driven roller 33, no skew of transfer belt 31 was observed.

When flexure 71 arises while drive roller 32 is being driven, transfer belt 31 tends to travel moving toward the center of drive roller 32 due to its elasticity (indicated by arrows 72). Further, since drive gear 62 for driving drive roller 32 is disposed on the left side end 32a of drive roller 32, transfer belt 31 is distorted due to the reactive force to the drive force etc., causing a skewing force 73 in the direction opposing drive gear 62. Thus, transfer belt 31 skews to the right in FIG. 6.

Accordingly, in the experiment, when the projected amount X3 was 0.05 mm or below even though it was positive, no skew was observed. That is, as shown in FIG. 5A, when drive roller 32 and driven roller 33 are arranged such that spacing X1 between the end 32a of drive roller 32 on the drive gear 62 side and the inner circumferential surface 61Aa of guide rib 61A is wider than spacing X2 between the end 33a of driven roller 33 on the drive gear 62 side and the inner circumferential surface 61Aa, it is possible to positively prevent transfer belt 31 from skewing.

Though the above embodiment was described by taking an example of transfer belt 31 for conveying recording paper as the belt having guide ribs 61A and 61B provided thereon, the present invention should not be limited to this. That is, guide ribs 61A and 61B may be formed in an intermediate transfer belt 31B (FIG. 4) to which the toner image T formed on the photoreceptor drum 21 is directly transferred to the belt surface. Also in this configuration, it is possible to positively prevent intermediate transfer belt 31B from skewing.

Accordingly, examples of the transfer belt for transferring the toner image formed on photoreceptor drum 21 may and should include both transfer belt 31 for transferring the toner image to recording paper and intermediate transfer belt 31B to which the toner image is directly transferred.

Further, though the above embodiment was described by exemplifying transfer belt 31 for conveying recording sheets to which toner images are transferred, the invention should not be limited to this configuration or the invention can be applied to a belt for conveying sheets to which no toner image is transferred. That is, the belt formed with guide ribs 61 and 61B may be applied not only to a transfer device but also can be applied to a mere sheet conveying device.

What is claimed is:

1. A transfer device comprising:
a transfer belt to which an image formed on an image bearer is transferred;
a drive roller that receives a drive force via a drive gear arranged at one end thereof; and
a driven roller that receives no drive force, characterized in that
the transfer belt is tensioned and supported between, and conveyed by, the two rollers,
the transfer belt has first and second guide ribs formed on the undersurface thereof,
the drive roller and the driven roller are specified to have a length approximately equal to each other and shorter than the spacing between the first and second inner circumferential surfaces of the first and second guide ribs, and
the drive roller and the driven roller are arranged such that the first spacing between a first end of the drive roller on the drive gear side and the first guide rib is wider than the second spacing between a second end of the driven roller on the drive gear side and the first guide rib.

2. The transfer device according to claim 1, wherein the transfer belt has an endless belt configuration.

3. An image forming apparatus characterized by inclusion of a transfer device defined in claim 1.

4. A conveying device comprising:
a conveying belt for conveying sheets;
a drive roller that receives a drive force via a drive gear arranged at one end thereof; and
a driven roller that receives no drive force, characterized in that
the conveying belt is tensioned and supported between, and conveyed by, the two rollers,
the conveying belt has first and second guide ribs formed on the undersurface thereof,
the drive roller and the driven roller are specified to have a length approximately equal to each other and shorter than the spacing between the first and second inner circumferential surfaces of the first and second guide ribs, and
the drive roller and the driven roller are arranged such that the first spacing between a first end of the drive roller on the drive gear side and the first guide rib is wider than the second spacing between a second end of the driven roller on the drive gear side and the first guide rib.

5. The conveying device according to claim 4, wherein the conveying belt has an endless belt configuration.

6. An image forming apparatus characterized by inclusion of a conveying device defined in claim 4.
